(19) United States
(12) Patent Application Publication
(10) Pub. No.: US 2026/0139740 A1
(43) Pub. Date: May 21, 2026

(54) Drive Apparatus for Driving a Component of a Container Treatment System

(71) Applicant: Krones AG, Neutraubling (DE)

(72) Inventors: Tobias EICHHAMMER, Bad Abbach (DE); Jörg TRIEBEL, Alteglofsheim (DE); Thomas EGGL, Obertraubling (DE); Stefan SCHERL, Bernhardswald (DE); Andreas KRAUS, Lappersdorf (DE); Roland EDERER, Brennberg (DE)

(21) Appl. No.: 19/388,105

(22) Filed: Nov. 13, 2025

(30) Foreign Application Priority Data
Nov. 15, 2024 (DE) 10 2024 133 476.2

(51) Int. Cl. F16J 15/3296; G01M 13/005

(52) U.S. Cl. CPC F16J 15/3296; G01M 13/005

(57) ABSTRACT

A drive apparatus for driving a component of a container treatment system includes at least one sealing element for sealing an interior of the drive apparatus and a monitoring system. The monitoring system is configured to monitor a wear condition of the sealing element.

### TECHNICAL FIELD

The present invention relates to a drive apparatus for driving a component of a container treatment system and a method for driving a component of a container treatment system by a drive apparatus.

### BACKGROUND

Drive apparatuses for driving a component of a container treatment system are known from the prior art.

For example, it is accordingly known to set a turntable of a rotary machine in rotation by a motor in order to carry out a treatment step on a container mounted on the turntable. In order to protect the motor from splash water, for example, it is further known to seal the interior of the motor against the environment by a seal. For example, it can be provided that the seal seals an opening of the interior, from which a movable drive element can be led out of an interior of the drive apparatus, against the environment by a sealing ring.

When the motor is started up and the drive element is set in rotation, for example, frictional forces between the seal and drive element lead to continuous wear of the seal and a reduction in the sealing effect. Over time, the interior of the motor can no longer be sealed against the environment. To prevent this, the seals are changed at regular intervals. However, since the exchange time can only be estimated, it happens that seals are regularly replaced too early or too late, which in turn can lead to high resource consumption or to the penetration of splash water into the drive apparatus.

### BRIEF SUMMARY

Aspects of the invention relate to a drive apparatus for driving a component of a container treatment system and a corresponding method which allow monitoring of a tightness of an interior of the drive apparatus with respect to an environment.

The drive apparatus according to the invention for driving a component of a container treatment system comprises at least one sealing element for sealing an interior of the drive apparatus and a monitoring system, wherein the monitoring system is configured to monitor a wear condition of the sealing element.

The drive apparatus can be any apparatus that is suitable for translational and/or rotational driving of the component of the container treatment system. For example, the drive apparatus can be a servo motor by which the component can be set in rotation. Alternatively, the drive apparatus can however also be a linear motor by which the component can be moved translationally. However, the drive apparatus can also be any other apparatus not explicitly listed here that is suitable for driving the component in a translational and/or rotational manner.

The component of the container treatment system can be any component that can be moved translationally and/or rotationally by the drive apparatus. For example, the component can be a container holder, such as a turntable. The turntable can be set in rotation, for example, using the drive apparatus. However, it can also be any other component of the container treatment system.

The interior can be a region of the drive apparatus at least partially sealed from the environment. For example, control electronics and/or a drive component of the drive apparatus can be stored in the interior, protected against environmental influences.

The sealing element can be provided to seal at least a portion of the drive apparatus against an environment. For example, it can be provided that the sealing element seals a portion of the drive apparatus against the environment, in which a drive component of the drive apparatus is led out of the interior of the drive apparatus. Alternatively, it can also be provided, for example, that the sealing element seals a replaceable subcomponent of the drive apparatus against the environment.

The monitoring system may be a system configured to determine the wear condition or a parameter related to the wear condition. The wear condition of the sealing element itself does not have to be determined, but can for example be determined indirectly via a parameter, such as an operating parameter, of the drive apparatus, which can be related to the wear condition of the sealing element. However, it can also be provided that the wear condition of the sealing element itself is determined, for example by measuring a parameter of the sealing element.

The wear condition can relate an actual condition of the sealing element to an initial condition of the sealing element. The initial condition can be a new condition of the sealing element, i.e., the condition of a new, unused sealing element. The wear condition can, for example, be specified in percent, wherein a wear condition of zero percent describes a new, unused sealing element, and a wear condition of 100 percent describes a completely worn sealing element. A completely worn sealing element can, for example, be a sealing element that does not ensure sufficient sealing of the interior against the environment. However, the new condition and the completely worn condition can also be described by any other percentage value or by any other suitable variable. For example, the wear condition can also be described binarily, wherein a wear condition of 0 describes, for example, a non-worn sealing element, and a wear condition of 1 describes a worn sealing element (or vice versa).

Because the drive apparatus according to the invention is configured to monitor the wear condition of the sealing element, it can be checked whether the sealing element provides sufficient sealing of the interior against the environment. This makes it possible to detect and prevent defects or damage to a component of the drive apparatus stored in the interior caused by insufficient sealing of the interior early on. Furthermore, the exchange time for a sealing element can be precisely timed, and a premature unnecessary exchange of the sealing element can be prevented.

In one embodiment, the monitoring system can comprise a humidity sensor and be configured to determine the wear condition of the sealing element based on a humidity value in the interior determined by the humidity sensor. Since the humidity value in the interior is directly related to the wear condition of the sealing element, the humidity value determined by the humidity sensor represents a particularly suitable variable for determining the wear condition of the sealing element.

Furthermore, it can be provided that the monitoring system comprises a sensor for determining an operating parameter of the drive apparatus and is configured to determine an operating parameter of the drive apparatus which is associated with a torque to be applied by the drive apparatus to achieve a certain rotational speed. If the drive apparatus is supposed to set the component in rotation, the drive apparatus is typically connected to the component via a drive element. In order to be able to transmit a rotation of the drive element to the component, the drive element can be led out of the interior via an opening, wherein the opening can be sealed against the environment with the sealing element. Since a frictional force between the drive apparatus (or between the drive element) and the sealing element decreases with an increasing wear condition and a torque to be applied by the drive apparatus to reach a certain rotational speed is directly related to the frictional force between the drive element and sealing element, the measurement of the operating parameter related to the torque represents a particularly suitable variable for determining the wear condition of the sealing element. The operating parameter may, for example, be a power consumption of the drive apparatus. In this case, the sensor can, for example, comprise a current measuring apparatus and be configured to determine the torque based on the power consumption of the drive apparatus. Alternatively, the sensor can also include a strain gauge to determine the torque. In this case, the operating parameter can be, for example, a resistance of the strain gauge. Furthermore, the sensor can also be configured as a magnetic inductive sensor or in any other suitable manner.

Instead of a sensor/current meter, the required torque can be determined via the current that is supplied to the drive unit. It is therefore possible to calculate the torque from the required current.

In one embodiment, it can be provided that the monitoring system is configured to compare the humidity value and/or the operating parameter with a reference humidity value and/or a reference operating parameter value, and to determine the wear condition of the sealing element based on the comparison. By comparing the measured humidity value and/or the measured operating parameter with the reference value, the wear condition of the sealing element can be quantified in a precise way.

In a further development of the preceding embodiment, the monitoring system can be configured to compare the wear condition with a reference value and, based on the comparison, to output information to an operator that the sealing element must be replaced or, based on the comparison, to output information to an operator which comprises a maintenance time at which the sealing element must be replaced. In this way, the replacement of a worn sealing element can be initiated or scheduled, and damage to any components stored in the interior can be prevented, and premature replacement of the sealing element can be avoided.

In one embodiment, it can be provided that the drive apparatus

comprises a pressure compensation component via which moisture present in the drive apparatus can be led out from the drive apparatus. Accordingly, for example, after replacing the sealing element, any residual moisture present in the interior of the drive apparatus can be removed from the interior. Furthermore, in the event that an exchange of a worn sealing element cannot be performed immediately, humidity in the interior can be monitored until the replacement.

Furthermore, it can be provided that the drive apparatus comprises a servo motor and the component comprises a turntable arranged on a rotary machine of the container treatment system, wherein the drive apparatus is configured to be arranged below the turntable and along a radial direction of the rotary machine. In this way, a specific drive apparatus for a turntable of a rotary machine can be realized.

In a further development of the preceding embodiment, a dimension of the drive apparatus can increase along one direction, wherein given an arrangement of the drive apparatus below the turntable along the radial direction of the rotary machine, the dimension of the drive apparatus increases along the radial direction. With an appropriate embodiment of the drive apparatus, the number of drive apparatuses and turntables arranged on the rotary machine can be maximized.

According to the invention, a method for driving a component of a container treatment system by a drive apparatus is further provided, wherein the drive apparatus comprises at least one sealing element for sealing an interior of the drive apparatus and a monitoring system. The method comprises monitoring a wear condition of the sealing element using the monitoring system.

By determining the wear condition of the sealing element, it can be checked by the method according to the invention whether a sufficient sealing of the interior against the environment is provided by the sealing element. In this way, defects or damage to a component of the drive apparatus stored in the interior caused by insufficient sealing of the interior can be prevented. Furthermore, the exchange time for a sealing element can be precisely timed, and a premature unnecessary exchange of the sealing element can be avoided.

In one embodiment of the method, the monitoring system can comprise a humidity sensor and determine the wear condition of the sealing element based on a humidity value in the interior determined by the humidity sensor. Since the humidity value in the interior is directly related to the wear condition of the sealing element, the humidity value determined by the humidity sensor represents a particularly suitable variable for determining the wear condition of the sealing element.

Furthermore, it can be provided that the monitoring system comprises a sensor for determining an operating parameter of the drive apparatus and determines an operating parameter of the drive apparatus which is associated with a torque to be applied by the drive apparatus to achieve a certain rotational speed. In order to be able to transmit a rotation of a drive element of the drive apparatus to the component, the drive element is typically led out of the interior of the drive apparatus via an opening, wherein the opening can be sealed against the environment with the sealing element. In order to seal the interior, the drive element and the sealing element are in contact with each other. Since a frictional force between the drive apparatus (or between the drive element) and the sealing element decreases with an increasing wear condition of the sealing element and a torque to be applied by the drive apparatus to reach a certain rotational speed is directly related to the frictional force between the drive element and sealing element, the measurement of the operating parameter related to the torque represents a particularly suitable variable for determining the wear condition of the sealing element.

In one embodiment of the method, it can also be provided that the monitoring system compares the humidity value and/or the operating parameter with a reference humidity value and/or a reference operating parameter value and determines the wear condition of the sealing element based on the comparison. By comparing the measured humidity value and/or the measured operating parameter with the reference value, the wear condition of the sealing element can be quantified in a precise way.

In a further development of the method according to the previous embodiment, it can be provided that the monitoring system compares the wear condition with a reference value and, based on the comparison, outputs information to an operator that the sealing element must be replaced or, based on the comparison, outputs information to an operator which comprises a maintenance time at which the sealing element must be replaced. In this way, the replacement of a worn sealing element can be initiated or scheduled, and damage to any components stored in the interior can be prevented.

In one embodiment of the method, it can be provided that the drive apparatus comprises a pressure compensation component via which moisture present in the drive apparatus is led out of the drive apparatus. Accordingly, for example, after replacing the sealing element, any residual moisture present in the interior of the drive apparatus can be removed from the interior. Furthermore, in the event that an exchange of a worn sealing element cannot be performed immediately, humidity in the interior can be monitored until the replacement.

Furthermore, it can be provided that the drive apparatus comprises a servo motor, and the component comprises a turntable arranged on a rotary machine of the container treatment system, and the drive apparatus is arranged below the turntable and along a radial direction of the rotary machine, wherein optionally, a dimension of the drive apparatus increases along one direction, wherein given an arrangement of the drive apparatus below the turntable along the radial direction, the dimension of the drive apparatus increases along the radial direction. In this way, a specific drive apparatus for a turntable of a rotary machine can be realized. The optional embodiment of the drive apparatus allows the number of drive apparatuses and turntables arranged on the rotary machine to be maximized.

### BRIEF DESCRIPTION OF THE FIGURES

FIG. 1 shows a drive apparatus for driving a component of a container treatment system in accordance with an embodiment.

FIGS. 2a and 2b show a drive apparatus for driving a component of a container treatment system in accordance with an embodiment.

### DETAILED DESCRIPTION

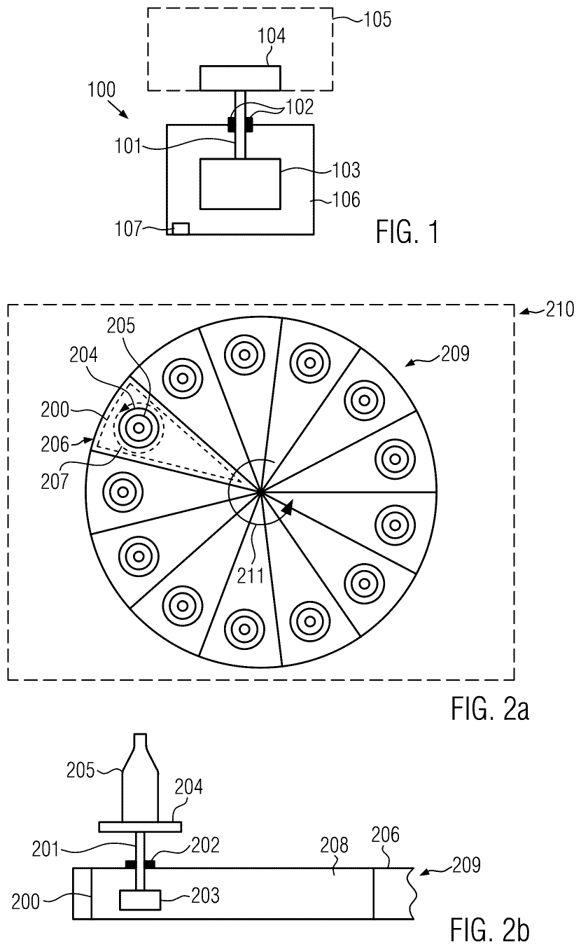

FIG. 1 shows a drive apparatus 100 for driving a component 104 of a container treatment system 105 in accordance with an embodiment.

According to the invention, the drive apparatus 100 comprises at least one sealing element 102 for sealing an interior 106 of the drive apparatus 100 and a monitoring system 103 which is configured to monitor a wear condition of the sealing element 102.

The drive apparatus 100 can be a drive apparatus 100 which can be configured for the translational and/or rotational driving of the component 104 of the container treatment system 105.

If the drive apparatus 100 is configured to rotationally drive the

component 104 of the container treatment system 105, the drive apparatus 100 can comprise, for example, a servo motor. However, the drive apparatus 100 may also comprise any other apparatus suitable for the rotational drive of the component 104.

If the drive apparatus 100 is configured to drive the component 104 of the container treatment system 105 in a translational manner, then the drive apparatus 100 can comprise, for example, a linear motor. Here too, the embodiment of the drive apparatus 100 with a linear drive is to be understood as exemplary so that the drive apparatus can also comprise any other apparatus which can be suitable for the translational driving of the component 104.

The drive apparatus 100 can be connected via at least one pluggable connection to a control unit via which the drive apparatus 100 can be controlled. If more than one drive apparatus 100 is provided, the drive apparatuses 100 can also be connected to one another by pluggable connections. The plug connectors may comprise rotatable angled plugs. Furthermore, contactless data transmission can also be provided between the drive apparatus 100 and the control unit or between drive apparatuses 100.

To supply power to the drive apparatus 100, it can also be provided to use a slip ring. In this way, for example, given a rotation of the entire drive apparatus 100, as is the case for example when the drive apparatus 100 is arranged on a rotary machine, a continuous power supply to the drive apparatus 100 can be ensured, and failures of the drive apparatus 100 due to cable breaks can be prevented.

The sealing element 102 can, for example, be provided to seal an opening of the interior 106 from the environment. As shown in FIG. 1, the opening can be an opening through which a drive element 101 of the drive apparatus 100 can be led out of the interior 106 of the drive apparatus 100 in order to be connected to the component 104 and to be able to drive it. The drive element 101 can accordingly be provided to transmit a translational and/or rotational movement generated by the drive apparatus 100 to the component 104.

A material from which the sealing element is made can be flexibly selected based on the desired application of the drive apparatus 100 in the container treatment system 105. For example, the sealing element can comprise a rubber and/or a plastics material.

A specific replacement tool may be provided for changing the sealing element. The replacement tool can, for example, be configured to press the sealing element 102 into the opening of the interior 106 of the drive apparatus 100 with a specific insertion depth. In this way, rechecking the insertion depth by a measuring tool can be avoided, and the sealing element exchange can be made more efficient. Furthermore, defects in the drive apparatuses 100 due to an incorrectly inserted sealing element 102 can be avoided.

In order to enable movement of the drive element 101 of the drive apparatus 100, the drive element can have a play relative to a wall of the interior 106. As shown in FIG. 1, the sealing element 102 can be provided between the wall of the interior 106 and the drive element 101 of the drive apparatus 100 in order to seal the interior 106 from an environment. For example, the seal 102 can prevent a fluid, such as a liquid, from passing from the container treatment system 105 into the interior 106 of the drive apparatus 100.

A shape of the seal can be selected, for example, depending on a shape of the drive element 101 of the drive apparatus 100.

If the drive element 101 has, for example, a cylindrical shape, the sealing element 102 can be configured as a sealing ring. This type of embodiment of the drive element 101 and the sealing element 102 can be provided, for example, in a drive apparatus 100 which is configured to rotationally drive the component 104 of the container treatment system 105.

If a translational movement of the component 104 is to be achieved by the drive element 101, it can also be provided, for example, that the drive element 101 has a cuboid shape, and the sealing element 102 has a square or rectangular shape.

Since the sealing element 102 is intended to seal the interior 106 of the drive apparatus 100, the sealing element can be in contact with the drive element 101 of the drive apparatus 100 shown in FIG. 1. During a rotational and/or translational movement of the drive element 101 of the drive apparatus 100, a frictional force between the sealing element 102 and the drive element 101 therefore counteracts a rotational and/or translational movement of the drive element 101. The frictional force may cause gradual wear of the sealing element 102 over time. With increasing wear of the sealing element, which can, for example, be accompanied by a removal of material from the sealing element, the frictional force between drive element 101 and sealing element 102 can change.

Since, with increasing wear of the sealing element 102, adequate sealing of the interior 106 of the drive apparatus 100 can no longer be ensured, a liquid released during the treatment of containers with the container treatment system 104 can, for example, enter the interior of the drive apparatus 100 and, for example, cause a defect in a control electronics and/or drive component of the drive apparatus 100 arranged in the interior.

To prevent this, the monitoring system 103 according to the invention is configured to monitor a wear condition of the sealing element 102. Accordingly, the monitoring system 103 allows an exchange time for the sealing element 102 to be precisely determined, whereby an unnecessary premature exchange of a still intact sealing element 102 can be avoided. Furthermore, the penetration of liquid or other undesirable substances into the interior 106 due to a worn sealing element 102 can be prevented. Accordingly, by using the monitoring system 103, the exchange of a sealing element 102 can be precisely scheduled, and resources can be saved. Furthermore, damage to components arranged in the interior 106 of the drive apparatus 100 can be prevented.

The monitoring system 103 can, for example, be configured to directly determine the wear condition of the sealing element 102 or to determine a parameter of the drive apparatus 100 and, based on the parameter, in turn to determine the wear condition of the sealing element 102.

The parameter can, for example, be an operating parameter of the drive apparatus 100, such as a control parameter for controlling an operating state of the drive apparatus 100. If the drive apparatus 100 is configured to rotatably drive the component 104, the operating parameter can be, for example, an operating parameter of the drive apparatus 100 which is related to a torque to be applied by the drive apparatus 100 to achieve a specific rotational speed. For this purpose, the monitoring system 103 can, for example, comprise a sensor for determining an operating parameter of the drive apparatus that is related to the applied torque and can be configured to determine, based on the operating parameter, a torque to be applied by the drive apparatus 100 to achieve a specific rotational speed.

The operating parameter may, for example, be a power consumption of the drive apparatus 100. In this case, the sensor can, for example, comprise a current measuring apparatus and be configured to determine the torque based on a power consumption of the drive apparatus 100. Alternatively, the sensor can also include a strain gauge for torque determination. In this case, the operating parameter can be, for example, a resistance of the strain gauge. Alternatively, the sensor may be configured as a magnetic inductive sensor or in any other suitable manner.

If the drive apparatus 100 is configured to drive the component 104 translationally, the operating parameter can be, for example, a force applied by the drive apparatus 100, which is required to accelerate the component 104 to a certain velocity.

However, the parameter of the drive apparatus 100 can also be an environmental parameter to which the drive apparatus 100 is exposed. For example, the parameter may be a humidity value in the interior of the drive apparatus 100. In order to determine the humidity value in the interior, the monitoring system 103 can comprise a humidity sensor and be configured to determine the wear condition of the sealing element 102 based on a humidity value in the interior 106 determined by the humidity sensor.

In order to determine the wear condition of the sealing element 102 based on the operating parameter and/or the humidity value in the interior of the drive apparatus 101, the monitoring system 103 can be configured to compare the operating parameter and/or the humidity value with a reference operating parameter value and/or a reference humidity value and to determine the wear condition based on the comparison.

If both the measured operating parameter as well as the measured humidity value are used to determine the wear condition, the accuracy with which the wear condition is determined can be increased. However, even if the wear condition is determined based on the operating parameter related to the torque or the humidity value, a sufficiently accurate determination of the wear condition can be achieved.

For determining and/or monitoring the wear condition, it can be provided, for example, that the monitoring system 103 comprises a computer unit with a processor and a storage unit, such as a non-volatile memory. A number of reference operating parameter values and/or reference humidity values can be saved in the memory unit. The reference operating parameter values and/or the reference humidity values can be assigned to a specific type of drive apparatus 100. Reference values can be saved in the memory unit for a plurality of different drive apparatuses 100. The monitoring system 103 can be configured to compare the measured operating parameter values and humidity values with the reference values for the corresponding drive apparatus 100. The reference operating parameter values and reference humidity values can, for example, be assigned to specific wear conditions so that the wear condition can be determined based on the measured operating parameter and/or humidity value. It can also be provided that at least one function is saved in the memory unit by which the wear condition can be determined based on the measured operating parameter and/or humidity value.

The wear condition can, for example, be specified in percent, wherein a wear condition of one hundred percent can describe a completely worn sealing element, and a wear condition of zero percent can describe a new, unused sealing element (or vice versa). However, a new and/or completely worn sealing element can also be described by any other percentage value or by any other suitable variable.

For example, it can also be provided that the wear condition is specified in binary form, wherein a wear condition of zero can mean, for example, that the sealing element is not worn, and a wear condition of one can mean, for example, that the sealing element is worn (or vice versa). In this case, it can be provided, for example, that the measured operating parameter and/or the measured humidity value is compared with at least one threshold value which can be saved in the memory unit described above. If the humidity value exceeds the threshold value and/or if the operating parameter falls below the threshold value, it can be provided, for example, that the wear condition assumes a binary value of one and indicates that the sealing element 102 is worn.

Furthermore, it can be provided that the drive apparatus 100 comprises a pressure compensation component 107 via which any moisture present in the drive apparatus 100 can be led out from the drive apparatus 100. The pressure compensation component 107 can, for example, be a membrane which is configured to remove moisture, such as water vapor, from the interior of the drive apparatus 100 and at the same time to prevent moisture from penetrating into the interior 106. The membrane can, for example, be a microporous membrane comprising polytetrafluoroethylene. The microporous membrane, for example, can comprise more than a billion small openings per cm² membrane region. An area occupied by an opening can be substantially 1/20,000 of the diameter of a water droplet and substantially 700 times the diameter of a water vapor molecule. This substantially means that a deviation of the area of the opening of 1/20,000 of the diameter of the water droplet or a deviation of the area of the opening of 700 times the diameter of the water vapor molecule is less than or equal to 20%, less than or equal to 10%, less than or equal to 5% or corresponds to a value of 1/20,000 of the diameter of the water droplet and 700 times the diameter of the water vapor molecule. In this way, a membrane can be provided which is waterproof and at the same time permeable to water vapor. In order to remove the moisture from the interior 106 in an efficient manner via the pressure compensation component 107 out of the interior 106, a heating apparatus can further be arranged in the interior 106 of the drive apparatus 100, by which a liquid that has penetrated into the interior 106 can be converted into the gaseous phase and can accordingly be led out from the interior 106 of the drive apparatus 100 via the pressure equalization component 107.

FIG. 2a and FIG. 2b show a further embodiment of a drive apparatus 200 for driving a component 204 of a container treatment system 210, wherein FIG. 2a shows a plan view of a rotary machine 209 of the container treatment system 210, and FIG. 2b shows a section through a portion of the rotary machine 209 of FIG. 2a. The embodiment of FIG. 2a and FIG. 2b can be combined with the embodiment of FIG. 1.

The rotary machine 209 of a container treatment system 210 shown in FIG. 2a has a plurality of container holders 204 for holding containers 205 which are arranged along the circumference of the rotary machine 209. The number of container holders 204 arranged around the circumference of the rotary machine 209 shown in FIG. 2a and the position at which they are arranged are to be understood by way of example. Accordingly, the rotary machine 209 can also comprise any other number of container holders 204 which are arranged at other positions of the rotary machine 209.

In the embodiment of FIG. 2a, the container holders 204 are configured as turntables 204 which can be set into rotation 207 by the drive apparatus 200. The drive apparatus 200 shown in FIG. 2a can comprise a servo motor for this purpose.

A turntable can comprise at least one contact opening for connecting the turntable to the servo motor. For example, it can be provided that a drive shaft of the servo motor comprises at least one connecting element which can be connected to the at least one contact opening of the turntable. For example, the turntable can be connected to the drive shaft via the at least one contact opening and the at least one connecting element via a screw connection.

The fact that the turntables 204 can be set into rotation 207 by the drive apparatus 200 is to be understood by way of example. Alternatively or additionally, the turntables 204 can also be moved by the drive apparatus 200, for example, translationally as well in a direction perpendicular to a rotation plane 211 of the rotary machine 209.

The drive apparatuses 200 arranged along the circumference of the rotary machine 209 can be connected in series via cable connections so that only one of the drive apparatuses 200 can be directly connected to a control unit for controlling the drive apparatuses, and the remaining drive apparatuses can be indirectly connected to the control unit via the other drive apparatuses.

As shown in FIG. 2a, the drive apparatus 200 can be arranged vertically below the turntable 204 along a radial direction of the rotary machine 209.

Furthermore, the drive apparatus 200 can be arranged either above or below a container table of the rotary machine 209 with respect to a vertical direction. The container table can have a plurality of holes which can be arranged symmetrically along a circumference of the container table and into which the drive apparatuses 200 can be screwed to the container table either from above or below. In this way, the drive apparatuses 200 can be efficiently protected against dirt and corrosion.

Furthermore, it can be provided that a dimension of the drive apparatus 200 increases along one direction and that a turntable and a drive apparatus 200 are each arranged in a region 206 of the rotary machine 209.

In the arrangement of the drive apparatus 200 shown in FIG. 2a below the turntable 204 along a radial direction of the rotary machine 209, a width of the drive apparatus 200 increases along the radial direction from a center point of the rotary machine 209 outwards. To achieve this, the drive apparatus 200 may have a triangular shape along the radial direction, as shown in FIG. 2a. The idealized triangular shape of the drive apparatus 200 shown in FIG. 2a is to be understood as exemplary. The drive apparatus 200 can, for example, also have slight deviations from the triangular shape or have any other shape whose dimension increases in the horizontal direction from the center point of the rotary machine 209 in the radial direction outwards. With a corresponding embodiment of the drive apparatus 200, a number of drive apparatuses 200 and turntables 204 which can be arranged on the rotary machine 209 can be maximized.

As already explained in connection with FIG. 1, the drive apparatus 200 comprises, as can be seen in the section shown in FIG. 2b through a portion of the rotary machine 209 shown in FIG. 2a, a sealing element 202 which seals an interior 208 of the drive apparatus 200 from an environment. The sealing element 202 can be provided to form an opening in the drive apparatus 200 through which a drive element 201 of the drive apparatus 200, by which driving of the component 204 of the container treatment system 209 can be achieved, wherein the component 204 in the embodiment of FIG. 2 a and b is the turntable 204 of the rotary machine 209. The arrangement of the drive apparatus 200 on the rotary machine shown in FIG. 2b as well as the arrangement of the drive element and the sealing element 202 in the drive apparatus 200 is to be understood by way of example. The components just described can also be arranged in any other suitable manner on the rotary machine and/or on the drive apparatus 200. For example, it can be provided that the drive apparatus 200 can be fastened in the vertical direction from below to the rotary machine 209 by at least one screw connection. The rotary machine 209 can comprise, in a portion to which the drive apparatus can be attached to the rotary machine, a recess through which the drive element 201 of the drive apparatus 200 can be guided through the rotary machine 209 and can drive the component 204 of the container treatment system 209.

As shown in the section shown in FIG. 2b through a portion of the rotary machine 209 shown in FIG. 2a, the drive apparatus 200 does not have to extend along the entire radial direction of the rotary machine starting from a center point of the rotary machine, but can also occupy only a partial length region, such as 70%, 50%, 30%, 15% or any other partial length region along the radial direction of the rotary machine.

Furthermore, the receiving apparatus 200 comprises a monitoring system 203 which is configured to monitor a wear condition of the sealing element 202. The monitoring system 203 can be configured according to the monitoring system 103 of the embodiment of FIG. 1.

We claim:

1. A drive apparatus for driving a component of a container treatment system, wherein the drive apparatus comprises:
at least one sealing element for sealing an interior of the drive apparatus; and
a monitoring system, wherein the monitoring system is configured to monitor a wear condition of the sealing element.

2. The drive apparatus according to claim 1, wherein the monitoring system comprises a humidity sensor and is configured to determine the wear condition of the sealing element based on a humidity value in the interior determined by the humidity sensor.

3. The drive apparatus according to claim 1, wherein the monitoring system comprises a sensor for determining an operating parameter of the drive apparatus and is configured to determine an operating parameter of the drive apparatus which is associated with a torque to be applied by the drive apparatus to achieve a certain rotational speed.

4. The drive apparatus according to claim 2, wherein the monitoring system is configured to compare the humidity value and/or the operating parameter with a reference humidity value and/or a reference operating parameter value, and to determine the wear condition of the sealing element based on the comparison.

5. The drive apparatus according to claim 4, wherein the monitoring system is configured to compare the wear condition with a reference value and, based on the comparison, to output information to an operator that the sealing element must be replaced or, based on the comparison, to output information to an operator which comprises a maintenance time at which the sealing element must be replaced.

6. The drive apparatus according to claim 1, wherein the drive apparatus comprises a pressure compensation component via which moisture present in the drive apparatus can be led out from the drive apparatus.

7. The drive apparatus according to claim 1, wherein the drive apparatus comprises a servo motor and the component comprises a turntable arranged on a rotary machine of the container treatment system, wherein the drive apparatus is configured to be arranged below the turntable and along a radial direction of the rotary machine.

8. The drive apparatus according to claim 7, wherein a dimension of the drive apparatus increases along a direction, wherein given an arrangement of the drive apparatus below the turntable along the radial direction of the rotary machine, the dimension of the drive apparatus increases along the radial direction.

9. A method for driving a component of a container treatment system by a drive apparatus, wherein the drive apparatus comprises at least one sealing element for sealing an interior of the drive apparatus and a monitoring system, the method comprising:
monitoring a wear condition of the sealing element using the monitoring system.

10. The method according to claim 9, wherein the monitoring system comprises a humidity sensor and the method further comprises determining the wear condition of the sealing element based on a humidity value in the interior determined by the humidity sensor.

11. The method according to claim 9, wherein the monitoring system comprises a sensor for determining an operating parameter of the drive apparatus and the method further comprises determining the operating parameter of the drive apparatus which is associated with a torque to be applied by the drive apparatus to achieve a certain rotational speed.

12. The method according to claim 10, wherein the monitoring system compares the humidity value and/or the operating parameter with a reference humidity value and/or a reference operating parameter value and the method further comprises determining the wear condition of the sealing element based on the comparison.

13. The method according to claim 12, wherein the monitoring system compares the wear condition with a reference value and, based on the comparison, outputs information to an operator that the sealing element must be replaced or, based on the comparison, outputs information to an operator that comprises a maintenance time at which the sealing element must be replaced.

14. The method according to claim 9, wherein the drive apparatus comprises a pressure compensation component via which moisture present in the drive apparatus is led out from the drive apparatus.

15. The method according to claim 9, wherein the drive apparatus comprises a servo motor, and the component comprises a turntable arranged on a rotary machine of the container treatment system, wherein the drive apparatus is arranged below the turntable and along a radial direction of the rotary machine, wherein optionally, a dimension of the drive apparatus increases along one direction, wherein given an arrangement of the drive apparatus below the turntable along the radial direction, the dimension of the drive apparatus increases along the radial direction.
